(19) United States
(12) Patent Application Publication
(10) Pub. No.: US 2025/0153958 A1
(43) Pub. Date: May 15, 2025

(54) MECHANICAL - PNEUMATIC METER OF SOLID MATERIALS FOR AGRICULTURAL MACHINES AND IMPLEMENTS

(71) Applicant: INDECAR MAQUINARIAS S.A., Caba (AR)

(72) Inventor: Sergio Gastón Ricardo, Caba (AR)

(73) Assignee: INDECAR MAQUINARIAS S.A., Caba (AR)

(21) Appl. No.: 18/506,703

(22) Filed: Nov. 10, 2023

(51) Int. Cl. B65G 53/46; A01C 15/00; A01C 15/04

(52) U.S. Cl. CPC B65G 53/4633; A01C 15/003; A01C 15/006; A01C 15/04

(57) ABSTRACT

A mechanical-pneumatic meter of solid materials for agricultural machines and implements that allows for an improved metering of the solid materials without the need of a forced suction or aspiration, covering the entire work width in a much more practical, simple and safe way, whether by metering the material either individually or combined with another type, and reducing, in turn, the negative impacts on the environment since it makes it possible to reuse those materials that have not been unloaded.

### FIELD OF THE INVENTION

This invention relates to the field of devices, means and arrangements employed in the agribusiness and, more particularly, to a mechanical-pneumatic meter of solids, such as granulate, powder, mixtures, seeds, fertilizers, etc., that, in contrast to conventional meters, allows for an improved individual or combined metering of solid materials in a much more practical way, without the need to perform a forced suction or aspiration for both the material loading and unloading before its final entrainment towards the unloading spouts or ducts by means of a cold or hot air stream generated by an outer source, while, in turn, this invention is environmentally friendly since those non-metered solids may now be reused in subsequent procedures without any inconvenience.

### PRIOR ART DESCRIPTION

It is well known in the field of the art that sowing or fertilizer machines comprise a chassis or main structure on which different components are mounted, such as a set of transport wheels, a seed or fertilizer central hopper, secondary hoppers for feeding seed distributors, a row unit mounted on a tube transversally to the chassis, a blown or aspired air turbine, and other implements that are well known in the art and which, consequently, shall not be described in detail.

With regard to the seed distributors, there exist pneumatic-type distributors that have a rotary plate that separates them in a negative pressurization or suction chamber and an operative chamber. Generally, seeds enter through a feed inlet, accumulate in a seed area, are deposited in cavities provided in the plate and are kept housed therein by the suction or negative pressurization performed from the vacuum chamber. Then, the seeds reach an area wherein the suction or negative pressurization is zero, thus falling by gravity into an unloading duct and then to the furrow.

Likewise, there is a horizontal-plate mechanical distributor used in thick grain seeders that operates furrow by furrow in minimum (direct) tillage and conventional sowing, and with seed feeding by means of gravity fall or an air stream (seeds entrained by a positive air stream towards the secondary hopper). Furrow seeders are designed to place seeds at spacings determined for each seed type. Sowing machines require to deposit seeds on the soil at a desired depth and with an even distribution among them. The seeder consists of a main hopper having a high load capacity from which discharge hoses are positioned in a downward direction towards the secondary hoppers wherein seeds are received and the grain meter distributes the seeds in a uniform way.

Although conventional seed or fertilizer meters or distributors of the prior art have been shown to work in practice, there still exists a series of shortcomings. One of them is related to the fall of the grain or fertilizer from the unloading tube or duct to the respective furrow. At present, the continuous synchronization in the granular material fall from the unloading piping to the furrow depends on the meter mechanism.

In practice, it usually happens that the granular material fall towards the furrow is not always performed in a synchronized or continuous way and, many times, there are certain time lags or interruptions between the fall of one seed and another seed. Time lags occur due to the granular material impact against the inner wall of the unloading tube thus causing the synchronization achieved by the meter to be lost. Likewise, it may also happen that the impact of the seeds or fertilizer against the tube inner wall generates desynchronization that makes two granular materials fall very near each other instead of falling at the proper sowing distance. Consequently, the distance between sown seeds is not constant thus leading to a big problem related to the sowing regularity.

On the other hand, meters or distributors of both seeds and fertilizer cannot perform combined downloadings of materials. In view thereof, the inventor of the present application has developed a fertilizer and/or seed double application system applicable to a mosquito-type automotive machine according to Patent Application Series No. P20200103489, which reference is accompanied herein and which system is defined in a hopper that is subdivided into four inner compartments of equal volume, two of them are front compartments and two of them are rear compartments, each of which define, at their lower area, a respective feeding bottom from which a plurality of outlet conducting tubes originates and each of said tubes receives the material individually delivered by a feed roll which axle is connected to a respective hydraulic actuator motor and each outlet conducting tube of the front compartments is linked to a respective outlet conducting tube of the rear compartments through a respective flexible tubular duct that extends between them, wherein each feeding bottom is in communication with an inner lung supply of a pressurized air stream generated by a turbine.

Although Patent Application No. P20200103489 has made it possible to improve metering processes and, in turn, allow for the combined or individual distribution of fertilizer materials or seeds either simultaneously or in an alternate way, the applicant of this invention has continued making researches and developing improvements that result in a better metering of solid materials.

### BRIEF DESCRIPTION OF THE INVENTION

It is therefore an object of this invention to provide a new meter of solid materials for agricultural machines and implements that allows for an improved grain fall from respective discharge pipes towards the furrow in a much more practical way in order to cover the entire work width without any inconvenience.

It is a further object of this invention to provide a mechanical-pneumatic meter of solid materials, such as seeds, solid fertilizers, powder and/or mixtures, urea, yeast, phosphate, etc.

It is also another object of this invention to provide a mechanical-pneumatic meter that generates a pressurized cold or hot air stream that circulates throughout the system and that is counteracted by the pressurization of the hopper by means of the diversion of the same pressurized cold or hot air stream provided by the turbine, in view of which the materials to be applied that are provided by metering gears are applied during the loading and unloading by gravitational force, without the need to apply an aspiration and/or suction process to achieve this goal.

It is a further object of the invention to provide a metering mechanism because the materials to be metered do not require to be mixed before their loading into the hopper since, instead, said mixture shall be made in the same mechanical-pneumatic meter and at the required proportion according to the activity and/or place where it shall be applied.

It is still another object of this invention to provide a meter wherein the metering of each material to be mixed shall be individually selected with the possibility of modifying it whenever it is necessary and without implying any alteration of the materials loaded in the hopper.

It is still a further object of this invention to provide a meter wherein all of the excess material may be individually unloaded at the end of the work thus allowing to reuse it for any subsequent work and preventing it from being released into the environment.

It is another object of this invention to provide a meter that does not require the existence of an intermediate body in front of the hopper but, instead, it is assembled directly to the hopper.

It is a further object of this invention to provide a mechanical-pneumatic meter of solid materials for agricultural machines and implements, which is coupled to or mounted on the lower part of a hopper that contains one or more materials to be metered and has at its lower part at least two unloading openings or outlets that are selectively obturatable by means of respective guillotines, wherein the meter comprises: at least a main body having at least two inner housings for the material reception, each of which coinciding and in communication with each corresponding unloading opening or outlet of the hopper; at least a hollow cylindrical body arranged within each housing and having a plurality of pairs of loading and unloading openings; at least a gear train mounted within each cylindrical body; and at least a lower compartment in operative communication with said unloading openings of said cylindrical bodies and in communication with at least a turbine and material unloading tubes or ducts.

### BRIEF DESCRIPTION OF THE DRAWINGS

For greater clarity and understanding of the object of this invention, it is illustrated in several figures, in which the invention is represented in one of the preferred embodiments, all of which are provided by way of example, wherein:

FIG. 1 shows a perspective view taken from the bottom of the mechanical-pneumatic meter of this invention, which is coupled to the lower part of a hopper that contains the solid material to be metered;

FIG. 2 shows a side view of the meter of the invention in a position coupled to a hopper;

FIG. 3 shows a perspective view of the meter of this invention;

FIG. 4 shows an enlarged view of the meter of the invention, wherein part of its interior may be partially seen;

FIG. 5 shows a section side view of the meter of the invention, wherein part of its inner structure may be seen even more detailed;

FIG. 6 is a perspective view taken from the bottom of the meter of this invention, which shows at least two openings or cuts through which the excess material falls into a housing specially designed for it;

FIG. 7 is an exploded view of a part of the meter of the invention, which shows the arrangement of a set of metering gears that shall perform the mechanical metering;

FIG. 8 is a perspective view of the meter of the invention, which shows the arrangement of cylinders with material inlet openings within which the metering gears are arranged; and

FIG. 9 is a perspective view of a manifold according to this invention, which allows for the connection between a turbine and the meter of the invention to entrain and propel by means of the generated air stream the material to be metered from the meter towards the respective unloading tubes.

### DETAILED DESCRIPTION OF THE INVENTION

With reference now to the figures, it may be seen that the invention consists in a new mechanical-pneumatic meter of solid materials for agricultural machines and implements that allows for an improved metering of solid materials without the need of a forced suction or aspiration, covering the entire work width in a much more practical, simple and safe way, whether metering the material either individually or combined with another type, and reducing, in turn, the negative impacts to the environment since it makes it possible to reuse those materials that have not been unloaded.

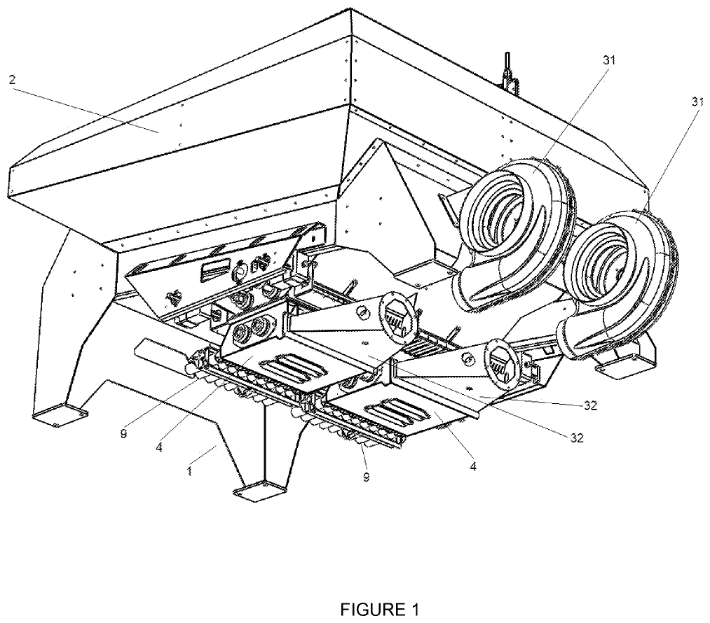

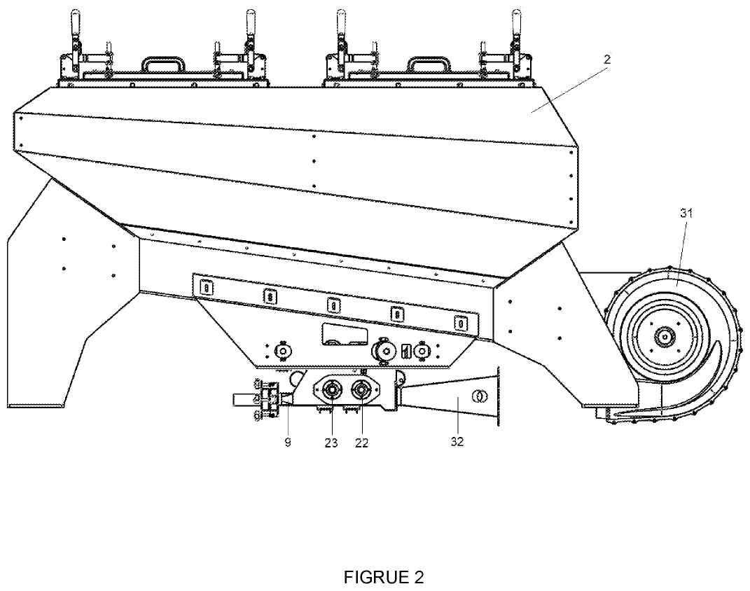

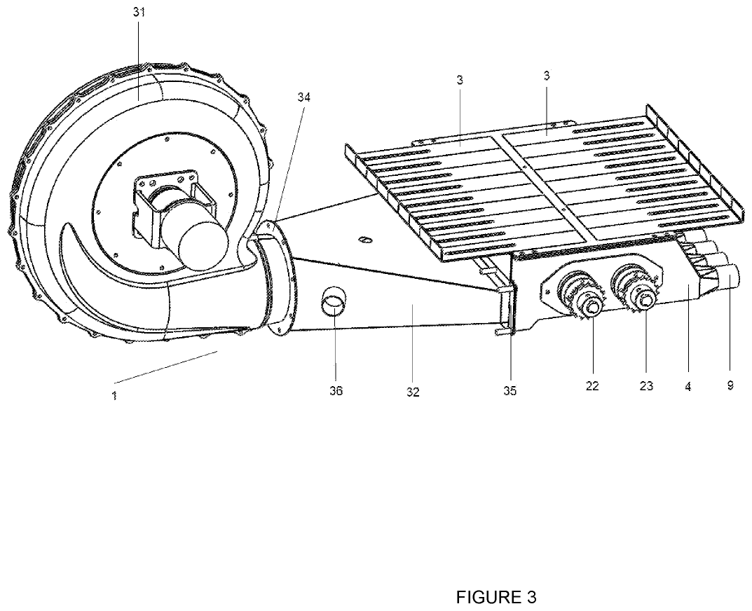

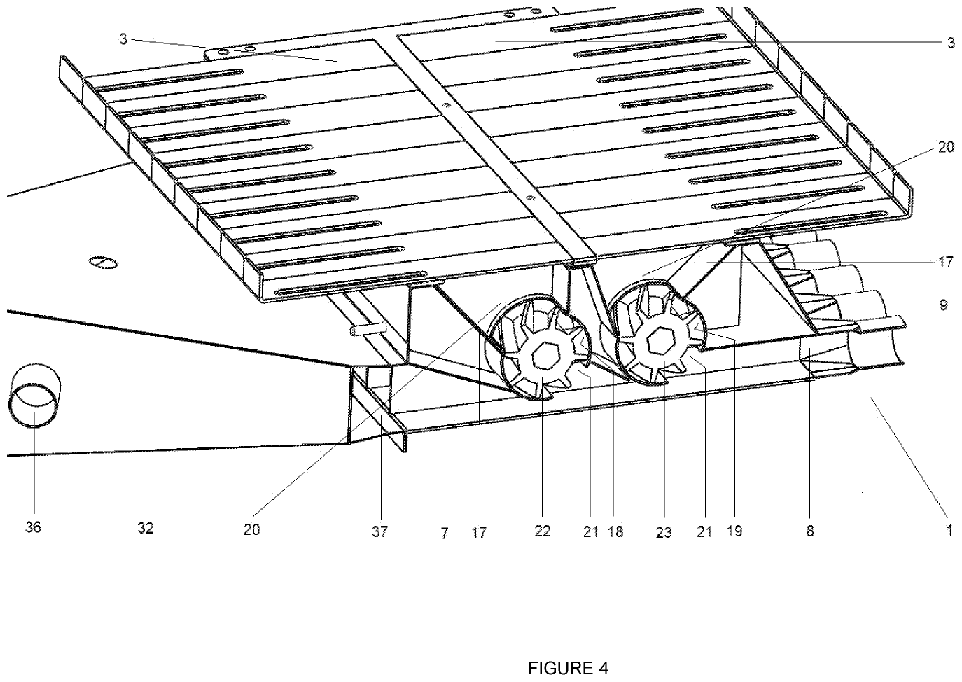

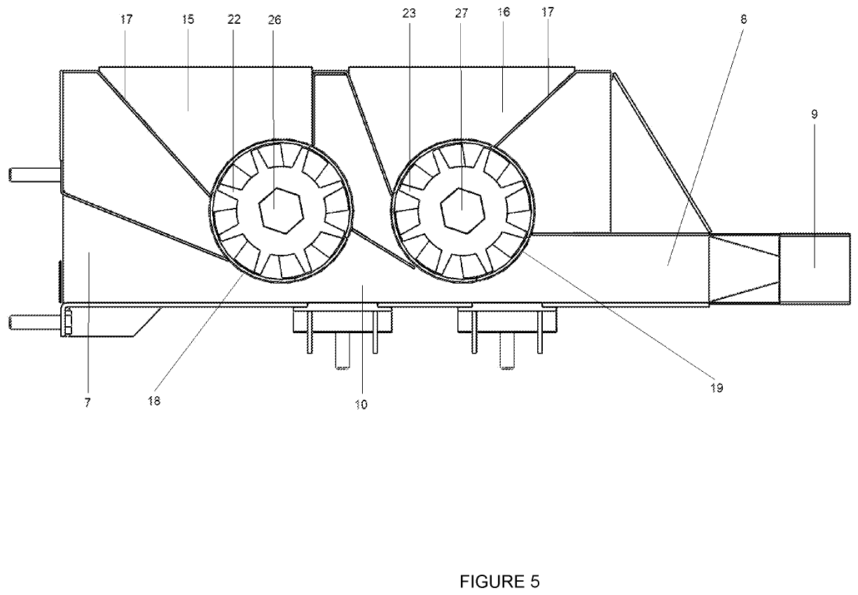

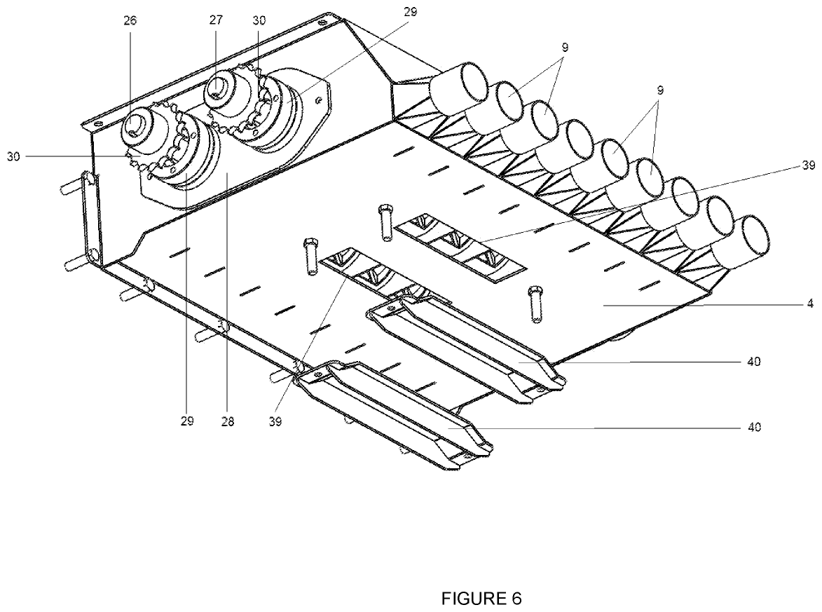

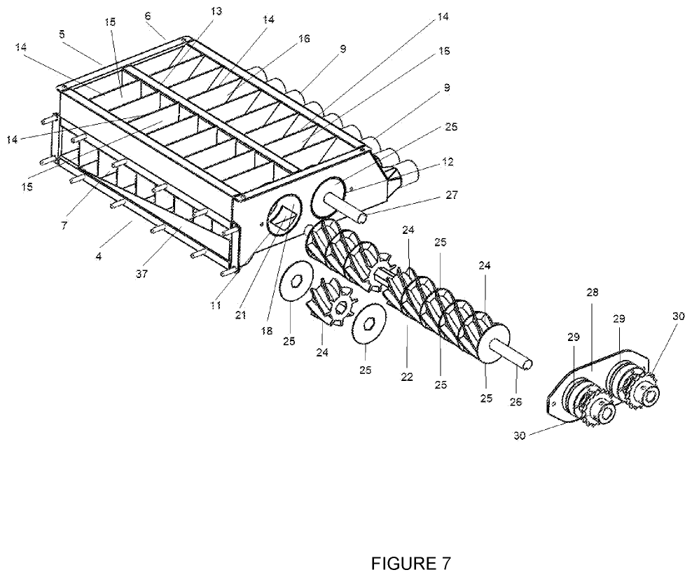

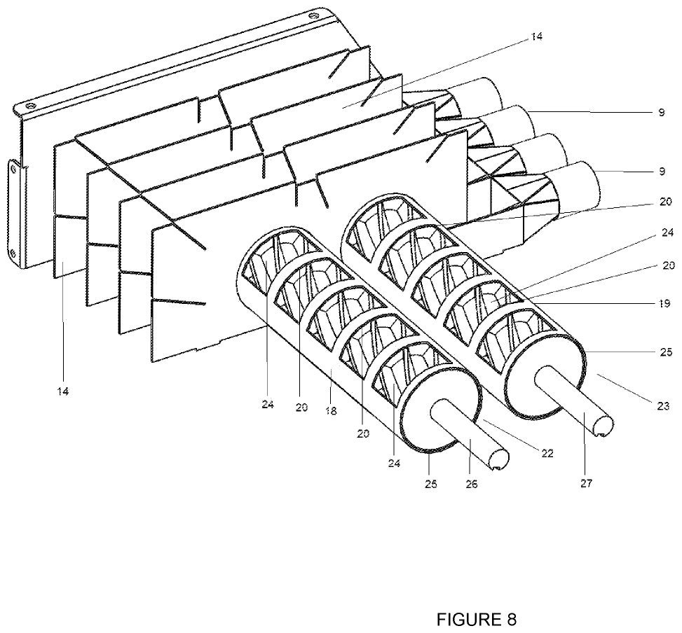

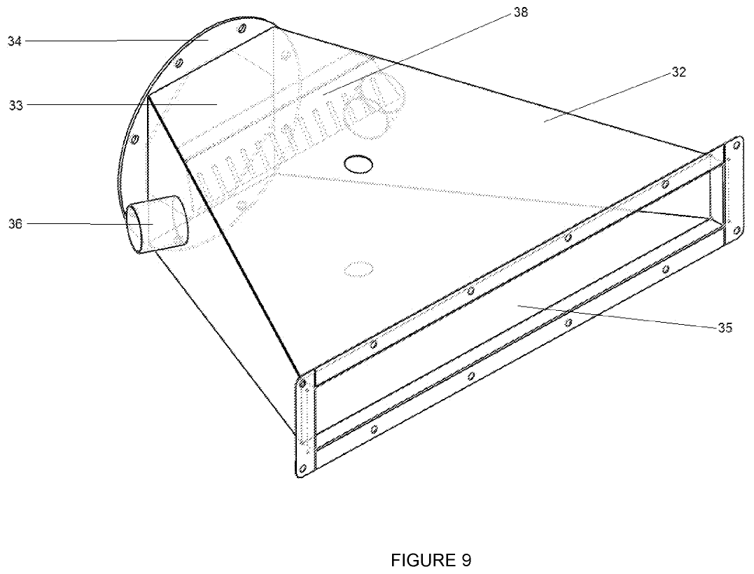

Therefore, and according to FIGS. 1 to 9, the mechanical-pneumatic meter of this invention is indicated by means of the general reference 1 and it is mounted on or coupled to the lower part of a hopper 2 that contains one or more materials to be metered and has in its lower part at least two unloading openings or outlets (not illustrated) selectively shutterable by means of respective guillotines 3 that shall slide so as to or so as not to enable the material to pass through.

Said meter 1 comprises at least one main body 4 having at least two inner housings 5 and 6 for the material reception, each of the housings coincides and is in communication with each corresponding unloading opening or outlet of the hopper 2, wherein the main body 4 further comprises a prismatic rectangular shape having at least one pressurized air inlet or entrance opening 7 and at least one outlet or exit opening 8 in operative communication with a plurality of unloading spouts or ducts 9, and said inlet 7 and outlet 8 are longitudinally made along respective opposite parallel faces of said main body 4 and in coincidence with a lower compartment 10 defined in said main body 4.

Likewise, said main body 4 is provided with at least respective circular openings 11 and 12 arranged in at least one face of said main body 4 and perpendicular to the parallel faces where said inlet or entrance opening 7 and outlet or exit opening 8 are located. Moreover, said main body 4 has at least an inner partition wall 13 that separates said material reception housings 5 and 6.

Furthermore, each housing 5 and 6 is divided or sectioned by a plurality of inner walls or plates 14 that define a plurality of individual sections 15-16 for the material reception, each individual material reception section 15-16 of each housing 5-6 is in linear coincidence with each individual material reception section 15-16 of the other adjoining housing 5-6, and each housing 5-6 is also provided with a lower slanted wall 17 that directs the material to be metered.

Each of said inner plates or walls 14 of each housing 5-6 has a central opening or hole (not illustrated) arranged in longitudinal alignment with each respective circular opening 11-12 made in one of the faces of said main body 4 in such a way that all of the circular holes and circular opening 11 or 12 arranged in alignment define a geometric space for mounting a respective cylindrical hollow body 18-19 extending along said main body 4.

Each of said cylindrical bodies 18-19 comprises a plurality of pairs of loading opening 20 and unloading opening 21 along thereof and each pair of loading opening 20 and unloading opening 21 is arranged in coincidence with each of the individual material reception sections 15-16. In this way, and together with the lower slanted wall 17 of the main body, all of the material to be metered from the hopper shall be directed to said loading openings 20 of the cylindrical body 18-19 to be then metered by means of a gear train 22-23 that shall be described below.

Each of the grain trains 22-23 is rotatably mounted within said cylindrical bodies 18-19, respectively, and comprises a plurality of gears 24, each of which is separated from each other by means of a pair of adjacent flat discs 25 so that each gear 24 is in coincidence with each individual material reception section 15-16 of the housings 5-6 and with each pair of corresponding loading opening 20 and unloading opening 21 of the cylindrical body 18-19. It is to be noted that each set of gears 24 and flat discs 25 is mounted on a hexagonal drive shaft 26-27, and each hexagonal shaft 26-27 is actuated through a drive mechanism that may comprise belts, pulleys, drive chains, any mechanism capable of being actuated in a manual, automatic or programmable manner so that each tooth or space delimited between the teeth of each gear, upon receiving the material to be metered, rotates at least 180° from the loading inlet 20 to the unloading outlet 21 to perform the unloading thereof.

It is to be highlighted that one of the ends of each hexagonal shaft 26-27 is mounted on a mounting head 28 comprised by a plurality of bearings 29 and gears, toothed rim or pulleys 30, while the other end may be mounted on a respective bearing (not illustrated). Likewise, in order to prevent the loss of material and ensure a tight seal within the main body 4, and, more particularly, within each individual material reception section 15-16 in the ends of said cylindrical bodies 18-19, respective seals are provided (not illustrated). A “sealed chamber” is thus defined and without the loss of air pressure, and for the complete safeguard thereof in a fore-hub (not illustrated) of each end of the rotatory hexagonal shafts, said seals are provided and made of any material that complies with the condition of being malleable, friction resistant, and acquires the shapes of the hole into which it is to be placed in order to prevent any possible pressurized cold or hot air leak.

By way of example, but without limitation for the invention, each of the hexagonal shafts 26-27 may receive its rotatory movement from a toothed rim associated by a drive chain with another toothed rim that is centered on the shaft of a clutch system, which performs a stopping or turning action and which, in turn, acquires its turning movement from even another toothed rim centered on the rotor shaft of a motor that may be a hydraulic, electric or wind motor; wherein the coupling of various diameters of the toothed rims shall provide a uniform, controlled and independent rotatory movement for each of the two hexagonal rotatory shafts, wherein each of the two hexagonal rotatory shafts in an independent and controlled way, through a manual, mechanical, digital programmed or automatized system, may stop, initiate or vary its turning speed according to the work conditions.

Likewise, the loading volume of the metering gears is determined by the hollow volume that is cylindrically established by the spaces between the teeth of the metering gear and, laterally, by the flat discs arranged at each side, thereby ensuring a constant material volume at each loading and unloading time by means of the rotatory effect of the shaft to which they are attached.

It may be seen so far that the material to be metered from the hopper 2 falls from each hopper compartment towards the main body 4 upon the movement of the guillotines 3 along a respective length thus allowing or not allowing for the passage according to the metering requirements of the moment, until each of the individual material reception sections 15-16 of each housing 5-6 is filled. It is to be reminded that each hopper compartment may have different materials to be metered, such as seeds, fertilizers, etc., and that their combination may be successfully achieved without any inconvenience by means of the invention. In this way, once the material is within each individual material reception section 15-16, the lower slanted wall 17 directs the material towards the respective loading inlets 20 of the cylindrical body 18-19. From there, the material to be metered meets the gears 24, which, by means of their rotary motion, convey the material to be unloaded through the unloading outlet 21 of each cylindrical body 18-19 and, from there, to the lower compartment 10.

To complete the metering process, at least a turbine 31 is provided in operative communication with the lower compartment 10 through a manifold 32 herein said manifold 32 has a polyhedron structure with an inlet 33 connected to said turbine 31 through a flange 34 and a rectangular outlet 35 connected to the air inlet 7 of the main body 4 and, in turn, said manifold 32 has at least a lateral unloading duct 36 in operative communication with each compartment of the hopper 2 in order to generate pressurization within the hopper 2 and allow for the gravity fall of the material deposited within it. In order to provide the cold or hot air stream with turbulence generated by the turbine 31, within the lower compartment 10, at least a control plate 37 is provided, said control plate 37 is positioned between said rectangular outlet of the manifold and said air inlet of the main body.

The control plate 37 may be positioned at a lower or upper position, or both of them in order to generate the required turbulence in the cold or hot air stream. Likewise, said control plate 37 may be made with different shapes and its purpose consists in causing a sufficient reduction in the pressurized cold or hot air stream to make it necessary to supply the same volume in each and every one of the row units, spreading spouts or unloading tubes, irrespective of the physical location at which they are distributed at the “arms or booms” of the agricultural machine or implement.

Likewise, said turbine 31 is provided at an area near its air inlet 33 of at least one grooved and slanted air baffle 38.

In this way, when the cold/hot air stream is generated, it will entrain the material that falls into the lower compartment 10 towards the respective unloading ducts or spouts 9 that shall or shall not be connected to other similar unloading tubes or means. It is to be noted that, by means of this invention, the metered materials that fall into the lower compartment 10 from the housing 5 are entrained by the air stream towards the unloading spouts or ducts 9. In the period between the unloading through the unloading outlet 21 and the arrival at the unloading spouts or ducts 9, the metered materials meet the metered material that fall from the housing 6. This configuration is not limitative since the numbering is merely exemplary and it may be reversed without any inconvenience since it is understood that the air stream entrains the metered materials in a single direction; that is to say, from the lower compartment to the unloading spouts or ducts 9, and the air stream is from the turbine 31. It is highlighted that, depending on the requirements of each metering, the amount of each material to be metered into each housing 5-6 may be varied by means of the actuation of the guillotines 3, which shall or shall not obturate the hopper unloading outlets.

Furthermore, in order to avoid the material waste and make an environmentally friendly meter, said main body 4 comprises a pair of lower material unloading slots 39, each of which is obturated by a lower removable gate 40 that shall be removed upon the metering completion so that those materials (seeds or fertilizer) that could not be metered may be subsequently reused in the following metering process instead of being disposed of in the environment.

It is in this way that the mechanical-pneumatic meter of solid materials for agricultural machines and implements of this invention is composed and built and it achieves an improved individual or combined metering of one or more materials in a much more practical, safe and proper way. Likewise, by means of the invention, a uniform, precise and environmentally friendly distribution is ensured since any waste existing in the meters of the prior art is reduced.

Therefore, the meter of the invention is suitable for use in sowing, cover sowing, fertilization and other agricultural tasks and it has been created to meter products such as urea, yeast, phosphate, or seeds (oat, rice, etc.) as well as solid fertilizers, powder and/or mixtures. The invention is also suitable to provide the material to a plurality of spreading spouts, row units or unloading tubes, that are required to perform a uniform and precise distribution, at each of the working widths during the machine forward motion or in a static situation.

Moreover, by means of the invention, there is the advantage that the pressurized cold or hot air stream that circulates throughout the system is counteracted by the hopper pressurization by the deviation of the same pressurized cold or hot air stream provided by the turbine, as a consequence of which the materials to be applied that are provided by the metering gears are applied both during the loading and unloading by gravitational force, without the need to apply an aspiration and/or suction process to achieve the goal. That is to say that since the hopper is pressurized by the incoming pressurized air stream from the manifold, the air pressures before and after the metering step are equaled thus allowing for the loading and complete free fall of the material supplied by the gears without the need of any kind of suction or aspiration of the material.

It is clarified that the metering gear trains facing each other are positioned in parallel and rotate in the same direction as the pressurized cold or hot air stream, irrespective of the forward motion of the agricultural machine or implement. In turn, each set of metering gears is in a separate position and works independently of the lower compartment through which the air stream passes.

Likewise, by means of the invention, the materials to be metered do not need to be mixed before being loaded into the hopper but, instead, said mixture shall be made in the same mechanical-pneumatic meter and in the required proportion according to the activity and/or place where it shall be applied. The metering of each material to be mixed shall be individually selected thus allowing to modify it whenever it is necessary and without implying any alteration in the materials loaded in the hopper.

Furthermore, it is of the utmost importance to keep the individuality of the materials in each section of the hopper both in the loading and unloading process, since upon completion of the work, all of the excess material may be individually unloaded thus allowing to use it in a subsequent work without being released in the environment. In addition to the above, the lower removable gates for the inner removal or recovery of the material contained in each hopper section act together with the guillotine opening or closure, thus reducing the negative impact on the environment since the individuality of the materials is maintained in contrast to the prior art where a pre-mixture that is added in the hopper is disposed of in most cases.

Furthermore, the invention does not require the existence of an intermediate body in front of the hopper since it is directly assembled to it. In turn, without requiring to be disassembled from the hopper, the set of metering gears may be laterally removed in a much more practical way.

1. A mechanical-pneumatic meter of solid materials for agricultural machines and implements, which is coupled to or mounted on the lower part of a hopper that contains one or more materials to be metered and has in its lower part at least two unloading openings or outlets that are selectively shutterable by means of respective guillotines, wherein the meter comprises:
at least a main body that has at least two inner housings for the material reception, each of which coincides and communicates with each corresponding unloading opening or outlet of the hopper;
at least a hollow cylindrical body arranged within each housing and having a plurality of pairs of loading and unloading openings;
at least a gear train mounted within each cylindrical body; and
at least a lower compartment in operative communication with said unloading openings of said cylindrical bodies and in communication with at least one turbine and some material unloading tubes or ducts.

2. A mechanical-pneumatic meter according to claim 1, wherein the main body comprises:
a prismatic rectangular shape;
at least one pressurized air inlet or entrance opening and at least one outlet or exit opening in operative communication with said unloading ducts, said inlet and outlet are longitudinally located along respective opposite parallel faces of said main body and in coincidence with said lower compartment;
at least respective circular openings arranged in at least one face of said main body and perpendicular to the parallel faces where said inlet or entrance opening and outlet or exit opening are located; and
at least an inner partition wall that separates said material reception housings.

3. A mechanical-pneumatic meter according to claim 2, wherein each housing is divided or sectioned by a plurality of inner walls or plates that define a plurality of individual material reception sections, each individual material reception section of each housing being in linear coincidence with each individual material reception section of the other adjoining housing, and each housing is also provided with a lower slanted wall that directs the material to said loading openings of the cylindrical body.

4. A mechanical-pneumatic meter according to claim 1, wherein each housing is divided or sectioned by a plurality of inner walls or plates that define a plurality of individual material reception sections, each individual material reception section of each housing being in linear coincidence with each individual material reception section of the other adjoining housing, and each housing is also provided with a lower slanted wall that directs the material to said loading openings of the cylindrical body.

5. The mechanical-pneumatic meter according to claim 1, wherein:
each of said loading openings defined in each cylindrical body is arranged in coincidence with each individual material reception section;
while
each of said inner plates or walls of each housing has a central opening or hole arranged in longitudinal alignment with each respective circular opening made in one of the faces of said main body, in such a way that all of the circular holes and circular opening arranged in alignment define a geometric space for mounting said cylindrical bodies.

6. The mechanical-pneumatic meter according to claim 1, wherein each gear train comprises a plurality of gears, each of which is separated from each other by means of a pair of adjacent flat discs so that each gear is in coincidence with each individual material reception section of the housings and with each pair of corresponding loading and unloading openings of the cylindrical body.

7. The mechanical-pneumatic meter according to claim 6, wherein each set of gears and flat discs is mounted on a hexagonal drive shaft, and each hexagonal shaft is actuated through a drive mechanism.

8. The mechanical-pneumatic meter according to claim 1, wherein said at least one lower compartment is in operative communication with at least one turbine through a manifold having a polyhedron structure with an inlet connected to said turbine through a flange and a rectangular outlet connected to the air inlet of the main body and, in turn, said manifold has at least one lateral unloading duct in operative communication with each compartment of the hopper.

9. The mechanical-pneumatic meter according to claim 1, wherein at least one control plate is provided, and said control plate is positioned between said rectangular outlet of the manifold and said air inlet of the main body.

10. The mechanical-pneumatic meter according to claim 2, wherein at least one control plate is provided, and said control plate is positioned between said rectangular outlet of the manifold and said air inlet of the main body.

11. The mechanical-pneumatic meter according to claim 3, wherein at least one control plate is provided, and said control plate is positioned between said rectangular outlet of the manifold and said air inlet of the main body.

12. The mechanical-pneumatic meter according to claim 4, wherein at least one control plate is provided, and said control plate is positioned between said rectangular outlet of the manifold and said air inlet of the main body.

13. The mechanical-pneumatic meter according to claim 5, wherein at least one control plate is provided, and said control plate is positioned between said rectangular outlet of the manifold and said air inlet of the main body.

14. The mechanical-pneumatic meter according to claim 6, wherein at least one control plate is provided, and said control plate is positioned between said rectangular outlet of the manifold and said air inlet of the main body.

15. The mechanical-pneumatic meter according to claim 8, wherein at least one control plate is provided, and said control plate is positioned between said rectangular outlet of the manifold and said air inlet of the main body.

16. The mechanical-pneumatic meter according to claim 1, wherein said main body comprises a pair of lower material unloading slots, each of which is obturated by respective lower removable gates.

17. The mechanical-pneumatic meter according to claim 1, wherein said turbine is provided at an area near its air inlet of at least one grooved and slanted air baffle.
